(19) United States
(12) Patent Application Publication
(10) Pub. No.: US 2014/0103863 A1
(43) Pub. Date: Apr. 17, 2014

(54) CHARGING DEVICE AND METHOD FOR CHARGING AN ELECTRICAL ENERGY STORE

(71) Applicants: Jochen Fassnacht, Calw (DE); Christoph Van Booven, Markgroeningen-Unterriexingen (DE)

(72) Inventors: Jochen Fassnacht, Calw (DE); Christoph Van Booven, Markgroeningen-Unterriexingen (DE)

(73) Assignee: ROBERT BOSCH GMBH, Stuttgart (DE)

(21) Appl. No.: 14/126,833

(22) PCT Filed: Apr. 23, 2012
(86) PCT No.: PCT/EP2012/057361

§ 371 Date: Dec. 16, 2013

(30) Foreign Application Priority Data
Jun. 17, 2011 (DE) 10 2011 077 716.4

(51) Int. Cl. H02J 7/02

(52) U.S. Cl. CPC H02J 7/022
USPC 320/107

(57) ABSTRACT

The present invention relates to a charging device (10) for charging an electrical energy store (20), comprising a first and a second input voltage terminal (12, 14), for connecting the charging device (10) to an AC voltage source, a first and a second output voltage terminal (16, 18) for connecting the charging device (10) to the energy store (20) to be charged, a rectifier voltage converter circuit (22), which on the input side is connected to the input voltage terminals (12, 14) and on the output side is connected to a first and a second intermediate circuit voltage terminal (24, 26) and is designed to provide an intermediate circuit DC voltage (UZK) between the intermediate circuit voltage terminals (24, 26), a DC voltage converter circuit (32) which on the input side is connected to the intermediate circuit terminals (24, 26) and on the output side is connected to the output voltage terminals (16, 18) of the charging device (10), wherein the DC voltage converter circuit (32) is designed to provide a DC output voltage (UO) and a DC output current (10) at the output terminals (16, 18), wherein the intermediate circuit DC voltage (UZK) can be set by means of the rectifier voltage converter circuit (22) in order to set an electrical power (P) that is transmitted from the input voltage terminals (12, 14) to the output voltage terminals (16, 18) or the energy store (20) to be charged.

The present invention relates to a charging device for charging an electrical energy store comprising a first and a second input voltage connection for connecting the charging device to an AC voltage source, a first and a second output voltage connection for connecting the charging device to the energy store to be charged, a rectifier voltage converter circuit, which is connected on the input side to the input voltage connections and is connected on the output side to a first and a second intermediate circuit voltage connection and is designed to provide a DC intermediate circuit voltage between the intermediate circuit voltage connections, a DC voltage converter circuit, which is connected on the input side to the intermediate circuit connections and is connected on the output side to the output voltage connections of the charging device, wherein the DC voltage converter circuit is designed to provide a DC output voltage and a direct output current at the output connections.

In addition, the present invention relates to a method for charging an electrical energy store, wherein a rectifier voltage converter circuit is connected to an AC voltage source, wherein a DC intermediate circuit voltage is provided by the rectifier voltage converter circuit, and wherein a DC output voltage and a direct output current for charging the electrical energy store are provided from the DC intermediate circuit voltage by means of a DC voltage converter circuit.

### PRIOR ART

In the field of electrical energy stores, it is generally known to charge energy stores by means of charging devices which are connected to a low-voltage public grid as AC voltage source in order to draw the corresponding power for charging the electrical energy store from the low-voltage grid. The charging devices generally have, on the input side, a PFC stage for drawing sinusoidal currents from the supply grid. These PFC stages make available a pulsating DC voltage to an intermediate circuit, which smoothes the pulsating AC voltage or the pulsating electrical power by means of an intermediate circuit capacitor. The electrical voltage smoothed in such a way is adjusted to an optimum charging voltage by means of a DC voltage converter corresponding to the state of charge of the energy store or the battery.

In order to meet the requirement for smoothing of the intermediate circuit voltage, intermediate circuit capacitors having a high capacitance are required (approximately 1 μF given a charging power of 3.3 kW), which intermediate circuit capacitors can be realized economically only with electrolyte capacitors. Electrolyte capacitors demonstrate severe ageing phenomena, however, depending on their current loading and their operating temperature. For use in the automotive sector, such electrolyte capacitors tend to be usable only to a limited extent as a result of the large specified temperature range and the thus reduced life.

Since the PFC stage sets a constant intermediate circuit voltage, the necessary voltage spread is provided during the charging operation of the electrical energy store by the DC voltage converter. Since the DC voltage converter therefore does not have a constant voltage transformation ratio, the electrically isolating converters generally used with an electromagnetic transmission element cannot have an optimum design. The electrically isolating soft-switching DC voltage converters used at present lose their soft-switching property above a specific transmission power, with the result that the efficiency is reduced by switching losses additionally occurring.

Such a charging device comprising a PFC stage and a DC voltage converter as series resonant converter is known, for example, from U.S. Pat. No. 5,581,171.

Disadvantages with the known charging devices therefore include the limited life, the high technical complexity, in particular the high control complexity for adjusting the charging voltage, and the high costs associated therewith.

### DISCLOSURE OF THE INVENTION

The present invention provides a charging device for charging an electrical energy store of the type mentioned at the outset in which the DC intermediate circuit voltage can be adjusted via the rectifier voltage converter circuit in order to set an electrical power which is transmitted from the input voltage connections to the output voltage connections or to the energy store to be charged.

In addition, the present invention provides a charging device for charging an electrical energy store of the type mentioned at the outset in which one or more capacitors are connected between the first and second intermediate circuit voltage connections, the total capacitance of said capacitors being less than 100 μF.

Finally, the present invention provides a method for charging an electrical energy store of the type mentioned at the outset, wherein the DC intermediate circuit voltage is adjusted by means of the rectifier voltage converter circuit in order to set an electrical power transmitted by the AC voltage source to the electrical energy store to be charged.

### ADVANTAGES OF THE INVENTION

As a result of the present invention, the control complexity involved in the charging of the electrical energy store can be reduced and, at the same time, the DC voltage converter and thus the entire charging device can be adapted and dimensioned better. Owing to the small dimensions of the capacitors between the rectifier stage and the DC voltage converter, capacitors which are less expensive and more reliable can be used, as a result of which the charging device is overall more reliable and less expensive. Overall, the charging device is therefore technically less complex and less expensive.

In other words, the voltage at the output voltage connections is determined by the electrical energy store connected, with the result that the output power can be adjusted via the output current. If the voltage between the intermediate circuit connections increases, the voltage difference between the input side and the output side of the DC voltage converter circuit increases, with the result that the current and therefore also the transmitted power increases. As a result, by adjusting the magnitude of the intermediate circuit voltage, the power transmitted to the electrical energy store can be adjusted. As a result, therefore, the transmitted charging power can be adjusted simply by regulating the intermediate circuit voltage.

It is particularly preferred if the DC voltage converter circuit forms galvanic isolation between the intermediate circuit connections and the output connections.

As a result, it is possible to prevent direct leakage currents from returning to the DC voltage source.

It is preferred here if the DC voltage converter circuit is in the form of a series resonant converter.

As a result, stray inductances of the integrated transformer which are present during operation can be compensated for, with the result that the current between the input and output is now only limited by the nonreactive winding resistance of the transformer.

It is further preferred if the DC voltage converter circuit is designed to provide a pulsating output current which has the same frequency as the DC intermediate circuit voltage.

As a result, the control complexity involved and the switching losses of the DC voltage converter circuit can be reduced.

It is further preferred if the capacitor(s) between the first and the second intermediate circuit voltage connection is/are in the form of (a) film capacitor(s).

As a result, a reliable intermediate circuit can be provided.

It is furthermore generally preferred if the rectifier voltage converter circuit has a rectifier circuit and a DC voltage converter circuit, which is in the form of a switched mode power supply, wherein the magnitude of the intermediate circuit voltage can be adjusted by means of the switched mode power supply.

As a result, a simple and inexpensive circuit for adjusting the magnitude of the DC intermediate circuit voltage is provided which involves a low level of control complexity and can adjust the corresponding voltage with low losses.

It is preferred here if the rectifier voltage converter circuit forms a power factor correction circuit.

As a result, the entire charging device acts as a resistive load, as a result of which the reactive power consumption is reduced or eliminated.

It is further preferred if the AC voltage source is a low-voltage public grid.

As a result, the charging device can be used in a substantially location-independent fashion for charging the electrical energy store.

It is further preferred if the DC intermediate circuit voltage is a pulsating DC voltage and an intermediate circuit current provided by the rectifier voltage converter circuit is a pulsating direct current, which is in phase with the DC intermediate circuit voltage.

As a result, the entire charging device acts as a resistive load.

It goes without saying that features, properties and advantages of the charging device according to the invention also apply or are also applicable correspondingly to the method according to the invention.

### BRIEF DESCRIPTION OF THE DRAWINGS

FIG. 1 shows, in schematic form, a charging device according to the invention for charging an electrical energy store;

FIG. 2 shows, in schematic form, a rectifier with a downstream DC voltage converter for reactive power correction;

FIG. 3 shows a series resonant converter; and

FIGS. 4a) to d) show the time profiles of the intermediate circuit current, the intermediate circuit voltage, the charging power of the electrical energy store and the output current.

### EMBODIMENTS OF THE INVENTION

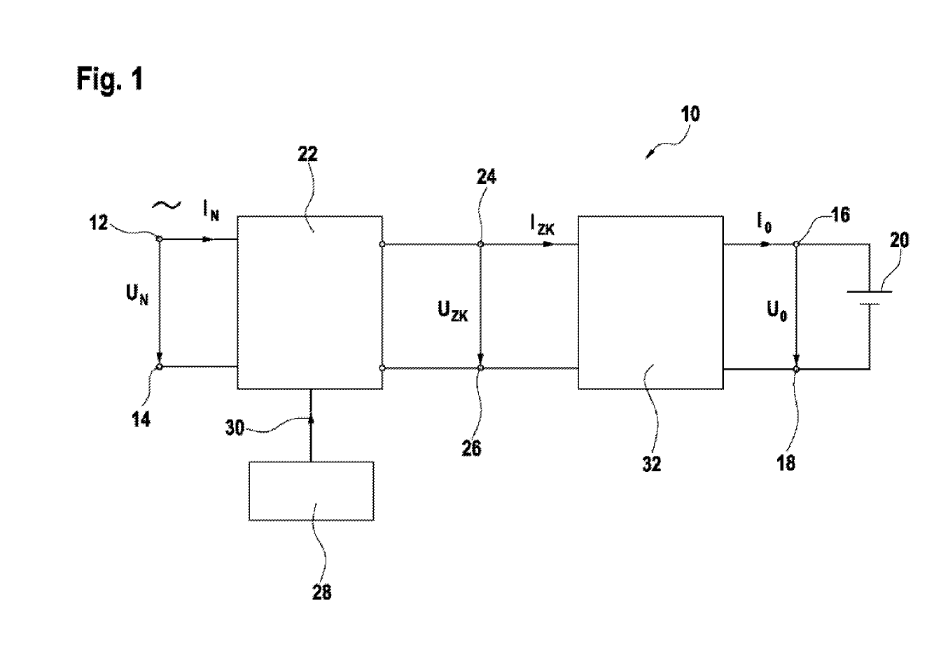

FIG. 1 shows schematically the circuit of a charging device according to the invention, which is generally denoted by 10.

The charging device 10 has a first input voltage terminal 12 and a second input voltage terminal 14, which together form a voltage input. In addition, the charging device 10 has a first output voltage terminal 12 and a second output voltage terminal 14, which together form a voltage output. The input voltage terminals 12, 14 are designed to be connected to an AC voltage source (not illustrated). The input voltage UN which preferably corresponds to the public grid voltage is present between the input voltage terminals 12, 14. That is to say that the AC voltage source in a preferred embodiment of the invention is a low-voltage public grid. The charging device 10 provides an input current IN across the input voltage terminals 12, 14. The input voltage UN is an AC voltage and the input current IN is an alternating current, which AC voltage and alternating current are preferably sinusoidal.

The output voltage terminals 16, 18 are connected to an electrical energy store 20 to be charged or to a battery 20 in order to correspondingly charge the electrical energy store 20 or the battery 20.

The input voltage terminals 12, 14 are connected to a rectifier voltage converter circuit 22, which is preferably in the form of a PFC stage. The rectifier voltage converter circuit 22 is connected on the output side to a first intermediate circuit terminal 24 and a second intermediate circuit terminal 26. The rectifier voltage converter circuit 22 forms a rectified pulsating DC voltage UZK between the intermediate circuit terminals 24, 26 from the AC input voltage UN. The rectifier voltage converter circuit 22 has a rectifier (not illustrated in any more detail in FIG. 1) and a DC voltage converter for adjusting the average intermediate circuit voltage UZK and forms a power factor correction circuit, as will be explained below. As a result, the DC voltage converter circuit 22 acts as a purely resistive load since there is no phase shift between UN and IN. In addition, the rectifier voltage converter circuit 22 can adjust the pulsating intermediate circuit voltage UZK as desired using simple means. The rectifier voltage converter circuit 22 is connected to a control unit 28, which adjusts the average intermediate circuit voltage UZK via a control signal 30. An intermediate circuit current IZK provided by the rectifier voltage converter circuit 22 at the intermediate circuit terminals 24, 26 and the intermediate circuit voltage UZK do not have a phase shift as a result of the power factor correction circuit.

The charging device 10 also has a DC voltage converter circuit 32, which is connected on the input side to the intermediate circuit terminals 24, 26 and on the output side to the output voltage terminals 16, 18. The rectifier voltage converter circuit 32 is preferably in the form of a resonant converter and converts the intermediate circuit voltage UZK and the intermediate circuit current IZK into an output voltage UO and an output current IO, which are used for charging the energy store 20. Since the voltage drop across the electrical energy store 20 is predetermined by the energy store 20 itself, a fixed voltage UO is set at the output voltage terminals 16, 18. As a result, the output current IO is now variable, as is also the electrical power output to the electrical energy store 20. Since the DC voltage converter 32 is preferably in the form of a series resonant converter with galvanic isolation, the output current IO is determined via the intermediate circuit voltage UZK and therefore the intermediate circuit current IZK which is set. Therefore, the transmitted charging power can be adjusted variably by adjusting the intermediate circuit voltage UZK.

In contrast to the prior art, in the charging device 10, a large intermediate circuit capacitor is not used for power smoothing. As a result, the output current IO has a frequency which is twice as high as the frequency of the AC voltage source. As a result, complex and expensive electrolyte capacitors with a limited life can be dispensed with. As a result, the charging power of the charging device 10 can thus be adjusted as desired via the intermediate circuit voltage UZK.

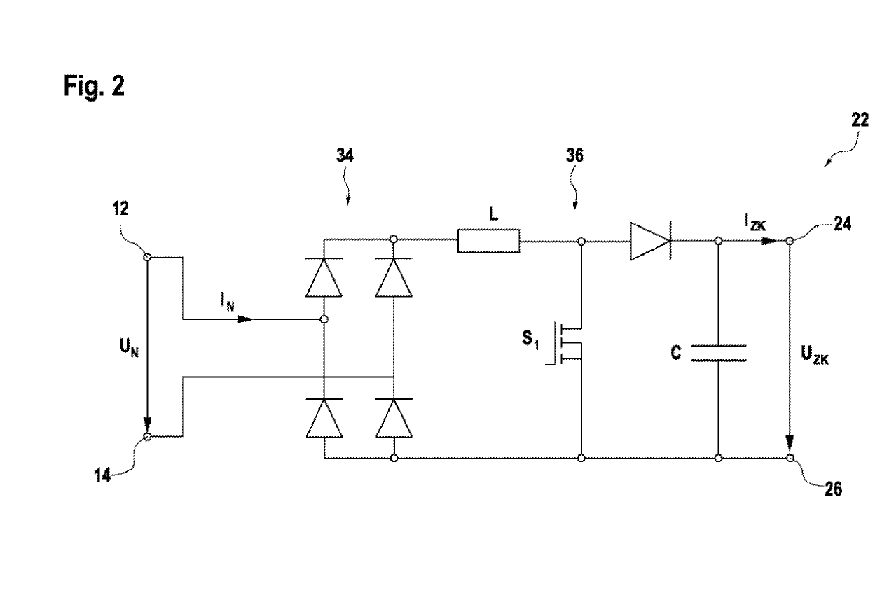

FIG. 2 illustrates schematically the rectifier voltage converter circuit 22. The rectifier voltage converter circuit 22 has a rectifier circuit 34 and a DC voltage converter 36.

The rectifier 34 is in the form of a conventional B2 rectifier and has two parallel current paths each having two diodes, between which the input voltage connections 12, 14 are connected. The rectifier circuit 34 provides a pulsating direct current or a pulsating DC voltage to the DC voltage converter 36. The DC voltage converter 36 is in the form of a step-up converter 36 and, in this embodiment, has a coil and a diode, between which a bridge having a transistor is connected, and a capacitance connected in parallel. Overall, the rectifier voltage converter circuit 22 represents a circuit with power factor correction which has the same response as a resistive load.

As a result, a slightly pulsating DC voltage UZK and a correspondingly pulsating direct current IZK are provided by the rectifier voltage converter circuit 22 from the AC voltage UN and the alternating current IN, said DC voltage and said direct current not having a phase shift, and wherein the mean value of the intermediate circuit voltage UZK can be adjusted virtually as desired via the DC voltage converter. For this, the transistor S1 is connected to the control unit 28. The elements which form the rectifier voltage converter circuit in FIG. 2 can be interpreted by way of example, wherein the respective components comprising the rectifier 34 and the DC voltage converter 36 can be replaced by any desired components with the same function.

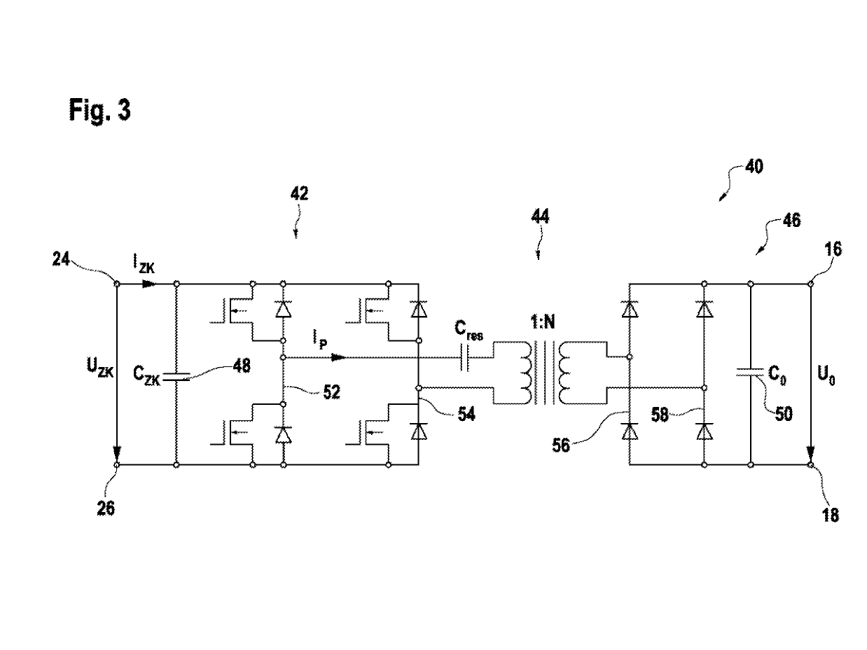

FIG. 3 illustrates a series resonant converter, denoted overall by 40. The series resonant converter 40 preferably forms the DC voltage converter circuit 22 of the charging device 10 according to the invention. The series resonant converter 40 has an inverter 42, a transformer 44 and a rectifier 46. On the input side, an intermediate circuit capacitor 48 which is in the form of a film capacitor and has a capacitance of approximately 50 μF is connected between the intermediate circuit terminals 24, 26. On the output side, an output capacitor 50 is connected between the output voltage terminals 16, 18.

The inverter 42 has two bridge branches 52, 54, which, by corresponding driving, convert an alternating current IP from the pulsating direct intermediate circuit current IZK, said alternating current IP forming the input current for the transformer 44. The driving of the inverter 42 or the transistors of the inverter 42 is performed with a 100% duty cycle, with the result that, during half of each cycle period, a positive current IP is provided to the transformer 44, and during the respective other half of the cycle period, a negative current IP is provided to the transformer 44. The clock frequency and the duty cycle are preferably set fixedly, as a result of which the control complexity can be reduced.

The transformer 44 has a constant transformation ratio above a fixed turns ratio and forms a galvanic isolation between the output voltage terminals 16, 18 and the intermediate circuit terminals 24, 26. The transformer provides a correspondingly transformed voltage and a corresponding current to the rectifier 46. The rectifier 46 is formed by two-way rectification with the bridge branches 56, 58 and converts the AC voltage or the alternating current which are provided by the transformer 44 into a pulsating DC voltage or a pulsating direct current, which is present at the output voltage terminals 16, 18 and forms the charging power for the energy store 20. Correspondingly, a sinusoidal output current IO is set which, owing to the lack of power smoothing, in the same way as the intermediate circuit voltage UZK has a frequency which corresponds to twice the frequency of the AC voltage source.

The voltage UO present between the output voltage sources 16, 18 is predetermined or adjusted by the voltage of the connected energy store 20. As a result, an output current IO corresponding to the intermediate circuit voltage UZK is set at the input of the inverter 42. As a result, the transmitted power of the entire charging device 10 can be adjusted via the intermediate circuit voltage UZK. As soon as the intermediate circuit voltage UZK increases, the voltage difference between the input and the output of the series resonant converter also increases, with the result that a correspondingly increased output current IO and therefore a correspondingly increased transmission power is set. Correspondingly, the output current IO or the transmitted charging power decreases as the intermediate circuit voltage UZK decreases. Thus, it is possible to suspend with separate regulation of the DC voltage converter circuit 32.

Therefore, virtually any desired charging power can be adjusted by means of the charging device 10 according to the invention, to be precise merely by virtue of driving the switched mode power supply 36 and by virtue of the thus adjustable intermediate circuit voltage UZK.

Owing to the fact that a constant voltage transformation ratio for the electrically isolating DC voltage converter circuit is set, an optimum working point can be set. Owing to the pulsating power, the DC voltage converter circuit needs to be designed for twice the transmission power for this operation, however, as a result of which the transformer volume increases significantly. In the present case, the transformer volume increases by approximately 70% in comparison with a design with power smoothing. By virtue of a suitable selection of the DC voltage converter in conjunction with the switching frequency used, this disadvantage can be compensated for, however.

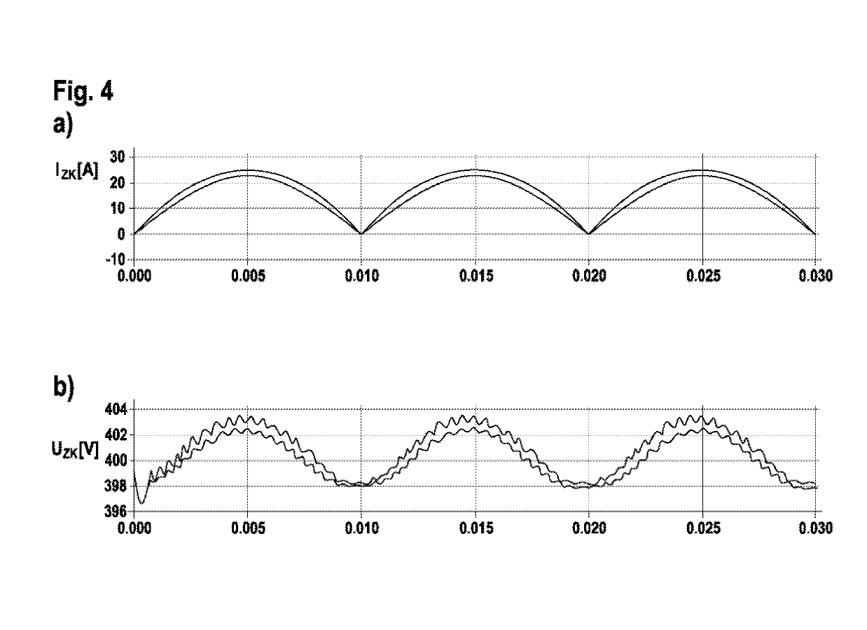

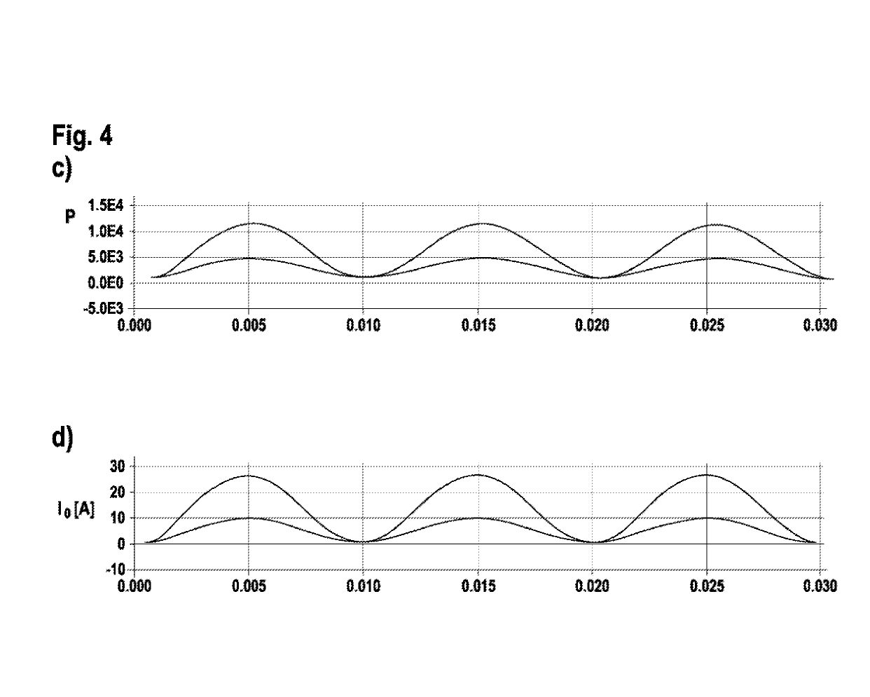

FIG. 4 schematically illustrates profiles of the intermediate circuit current IZK, the intermediate circuit voltage UZK, the battery charging power P and the battery charging current IO.

FIG. 4a) shows the intermediate circuit current IZK, which is in the form of a pulsating direct current, with a frequency of 100 Hz, which corresponds to twice the frequency of the AC voltage source or twice the grid frequency. It can be seen from FIG. 4a) that the intermediate circuit current IZK is merely rectified, wherein no smoothing is performed by an intermediate circuit capacitor.

FIG. 4b) shows the intermediate circuit voltage UZK, which is in the form of a pulsating DC voltage, wherein slight smoothing is performed by virtue of the low capacitance of the intermediate circuit capacitor 48. The intermediate circuit voltage UZK has a fundamental frequency of 100 Hz, which corresponds to twice the frequency of the AC voltage source and is in phase with the intermediate circuit current IZK. In addition, the intermediate circuit voltage has a further signal with a higher frequency, which is caused by the clocking of the switched mode power supply 36.

FIG. 4c) illustrates the battery charging power, which results from the product of the output voltage UO and the output current IO. The charging power is likewise pulsating with a frequency of 100 Hz and is in phase with UZK and IZK.

FIG. 4d) illustrates the charging current JO, which is likewise a pulsating direct current with a frequency of 100 Hz. It is therefore clear that the battery or the energy store 20 is charged with a pulsating direct current. The thus increased current loading for the semiconductor diodes of the rectifier 46 can be compensated for or overcompensated for by the lower switching losses in the galvanically isolated transformer over the entire voltage or power range of the energy store 20 since the increased losses in the diodes are lower than the reduction of the switching losses.

By virtue of the charging device, virtually any desired energy stores 20 can be charged, wherein, however, the provided voltage of the energy store 20 is limited by blocking ability of the transistors and diodes used. For the case of very high battery voltages, semiconductor components (transistors and diodes) which have a relatively high blocking ability need to be used both for the rectifier voltage converter circuit 22 and for the DC voltage converter circuit.

1. A charging device (10) for charging an electrical energy store (20), comprising
a first and a second input voltage connection (12, 14) for connecting the charging device (10) to an AC voltage source,
a first and a second output voltage connection (16, 18) for connecting the charging device (10) to the energy store (20) to be charged,
a rectifier voltage converter circuit (22), which is connected on the input side to the input voltage connections (12, 14) and is connected on the output side to a first and a second intermediate circuit voltage connection (24, 26) and is designed to provide a DC intermediate circuit voltage (UZK) between the intermediate circuit voltage connections (24, 26),
a DC voltage converter circuit (32), which is connected on the input side to the intermediate circuit connections (24, 26) and is connected on the output side to the output voltage connections (16, 18) of the charging device (10), wherein the DC voltage converter circuit (32) is designed to provide a DC output voltage (UO) and a direct output current (IO) at the output connections (16, 18),
characterized in that
the DC intermediate circuit voltage (UZK) can be adjusted via the rectifier voltage converter circuit (22) in order to set an electrical power (P) which is transmitted from the input voltage connections (12, 14) to the output voltage connections (16, 18) and/or to the energy store (20) to be charged.

2. The charging device as claimed in claim 1, characterized in that the DC voltage converter circuit (32) forms galvanic isolation (44) between the intermediate circuit connections (24, 26) and the output voltage connections (16, 18).

3. The charging device as claimed in claim 1, wherein the DC voltage converter circuit (32) is in the form of a series resonant converter (32).

4. The charging device as claimed in claim 1, characterized in that the DC voltage converter circuit (32) is designed to provide a pulsating output current (IO), which has the same frequency as the DC intermediate circuit voltage (UZK).

5. The charging device as claimed in claim 1, characterized in that one or more capacitors (48) are connected between the first and second intermediate circuit voltage connections (24, 26), the total capacitance of said capacitors being less than 100 μF.

6. The charging device as claimed in claim 5, characterized in that the capacitor(s) (48) is/are in the form of (a) film capacitor(s).

7. The charging device as claimed in claim 1, characterized in that the rectifier voltage converter circuit (22) has a rectifier circuit (34) and a DC voltage converter circuit (36), which is in the form of a switched mode power supply (36), wherein the magnitude of the intermediate circuit voltage (UZK) can be adjusted by the switched mode power supply (36).

8. The charging device as claimed in claim 7, wherein the rectifier voltage converter circuit (22) forms a power factor correction circuit.

9. The charging device as claimed in claim 1, wherein the AC voltage source is a low-voltage public grid.

10. The charging device as claimed in claim 1, characterized in that the DC intermediate circuit voltage (UZK) is a pulsating DC voltage and an intermediate circuit current (IZK) provided by the rectifier voltage converter circuit (22) is a pulsating direct current, which is in phase with the DC intermediate circuit voltage (UZK).

11. A method for charging an electrical energy store (20), wherein a rectifier voltage converter circuit (22) is connected to an AC voltage source, wherein a DC intermediate circuit voltage (UZK) is provided by the rectifier voltage converter circuit (22), and wherein a DC output voltage (UO) and a direct output current (IO) for charging the electrical energy store (20) are provided from the DC intermediate circuit voltage (UZK) by a DC voltage converter circuit (32), characterized in that the DC intermediate circuit voltage (UZK) is adjusted by the rectifier voltage converter circuit (22) in order to set an electrical power (P) transmitted by the AC voltage source to the electrical energy store (20) to be charged.

12. The charging device as claimed in claim 1, characterized in that one or more capacitors (48) are connected between the first and second intermediate circuit voltage connections (24, 26), the total capacitance of said capacitors being less than 50 μF.
